(19) United States
(12) Patent Application Publication
(10) Pub. No.: US 2005/0010780 A1
(43) Pub. Date: Jan. 13, 2005

(54) Method and apparatus for providing access to personal information

(76) Inventors: John Richard Kane, Fox River Grove, IL (US); Thomas S. Messerges, Schaumburg, IL (US)

Correspondence Address: KENNETH A. HAAS;Motorola, Inc. - Law Department, Law Department, Schaumburg, IL, 60196, US

(21) Appl. No.: 10/616,442

(22) Filed: Jul. 9, 2003

(51) Int. Cl. H04L 9/32

(52) U.S. Cl. 713/182; 713/193

(57) ABSTRACT

A personal database (102) is maintained by the owner of personal information that is to be shared. When a requestor (103) requests personal information, the request is made to a token generation subsystem (101) that produces a token that allows access to the personal database. The personal database will allow access to information only identified by the token.

### FIELD OF THE INVENTION

The present invention relates generally to the secure transfer of information and in particular, to a method and apparatus for providing access to personal information.

### BACKGROUND OF THE INVENTION

Many platform and service providers are moving to consolidate the holding of personal information and make the access and use of it easier for Internet users. For instance, Yahoo® and America Online® monitor behavior of registered users and offer to hold their credit card information so that they need not fill in the data at each purchase site they encounter. Similarly, Microsoft® has introduced TrustBridge® (Passport) as part of its product portfolio. TrustBridge® is an information holding service that keeps users account/password pairs and automatically (based on Kerberos) logs them onto accounts requiring this data. To counter the threat of Microsoft “owning” all user information, a number of corporations have formed the Liberty Alliance to provide an open specification for such a service.

With all of the above-mentioned services a problem exists in that an entity other than the user is in possession of sensitive personal information. In other words, the above approaches require the user to place their information in a storage facility under the control of a third party. Because of this, users may be hesitant to provide such information. Therefore a need exists for a method and apparatus for providing access to personal information that does not require a third party to have access to all of the personal information.

### BRIEF DESCRIPTION OF THE DRAWINGS

FIG. 1 is a block diagram of an information-sharing system in accordance with the preferred embodiment of the present invention.

FIG. 2 is a block diagram of an information-sharing system in accordance with an alternate embodiment of the present invention.

FIG. 3 is a more-detailed block diagram of the systems of FIG. 1 and FIG. 2.

FIG. 4 is a flow chart showing operation of the system of FIG. 3 in accordance with the preferred embodiment of the present invention.

### DETAILED DESCRIPTION OF THE DRAWINGS

To address the above-mentioned need, a method and apparatus for providing access to personal information is provided herein. In accordance with the preferred embodiment of the present invention a personal database is maintained by the owner of the personal information that is to be shared. When a requestor requests access to personal information, the request is made to a token generation subsystem that produces a token that allows access to the personal database. Access to personal information within the personal database comprises access to read the existing personal information, add new personal information, remove old personal information, or modify existing personal information. The personal database will require a token to allow a particular type of access to personal information. The token will identify the type of access that is allowed (e.g., read, write, modify).

Because the owner of the personal information maintains the database, the above solution allows for access to the personal information without the need for disclosing the information to anyone other than the requestor of the information. Therefore users will be less hesitant to provide such information to requesters of the information.

The present invention encompasses a method for providing access to personal information. The method comprises the steps of receiving, by an electronic device, a request for access to the personal information, the request originating from an entity external to the electronic device. In response, the external entity is provided with cryptographically protected access information allowing the entity access to the personal information existing within a personal database also existing external to the electronic device.

The present invention additionally encompasses a method for providing access to personal information. The method comprises the steps of receiving, on an electronic device, a request for the personal information, the request originating from an entity external to the electronic device. In response, a personal database is provided with cryptographically protected access information instructing the database to forward the personal information to the external entity.

Finally, the present invention encompasses an electronic device comprising an authorization manager receiving a request for the personal information, the request originating from an entity external to the electronic device and verifying the requester of the personal information as legitimate. The apparatus additionally comprises a token generator, providing either an external database or the external entity with cryptographically protected access information instructing the database to forward the personal information to the external entity.

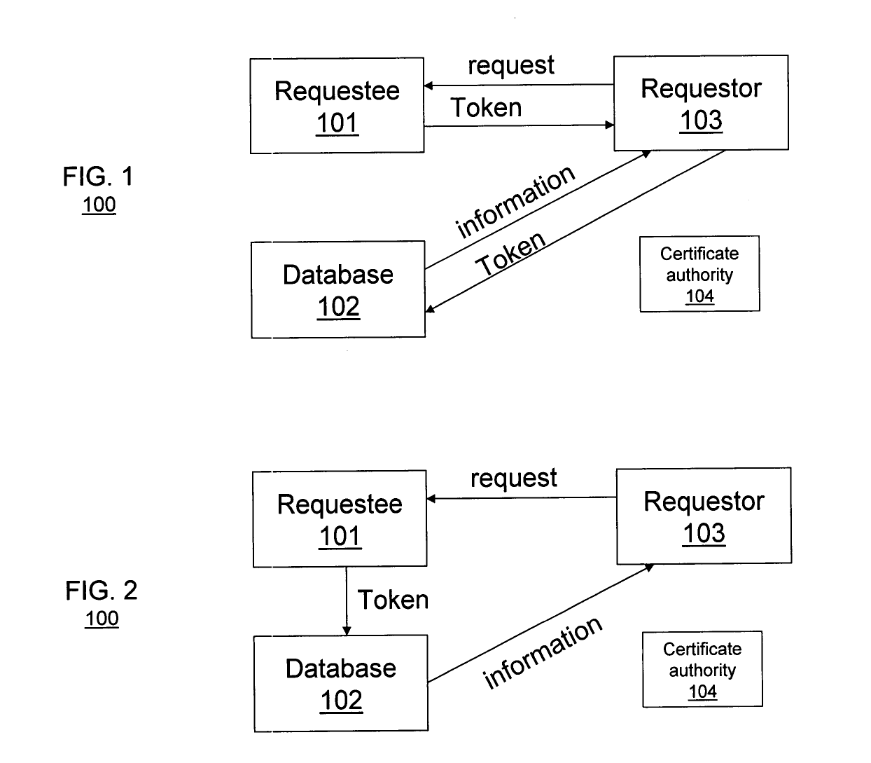

Turning now to the drawings, wherein like numerals designate like components, FIG. 1 is a block diagram of information-sharing system 100 in accordance with the preferred embodiment of the present invention. As shown, system 100 comprises certificate authority 104, requester 103, database 102, and requestee 101. In the preferred embodiment of the present invention requestor 103 comprises an electronic device that requests access to personal information from requestee 101. For example, requestor 103 may comprise a computer running software that requests credit card information from requestee 101, may comprise a computer running software that requests certain medical records from requestee 101, or may comprise an online store that requests permission from requestee 101 to write a receipt for recently purchased goods into the database 102.

Similarly, requestee 101 comprises an electronic device such as, but not limited to a mobile cellular telephone, a set-top box remote controller, a personal computer, a specialized device like a key-fob, or any other electronic device capable of receiving a request for information. In the preferred implementation, database 102 exists separate from requestee 101 and preferably comprises storage means and logic circuitry capable of providing limited access to storage means. For example, database 102 may comprise a home information controller attached to the Internet with a firewall and intrusion prevention technologies. In alternate implementations, database 102 may comprise a set-top box or personal controller capable of storage, communications, and computation. It should be noted that in the preferred embodiment of the present invention, database 102 is regarded as a personal database under the control of the individual whose data is stored within the database.

Certificate authority 104 provides a public-key infrastructure that allows a requestee 101 and a database 102, in system 100, to verify the trustworthiness of a requestor device 103. That is, certificate authority 104 uses a system based on public-key cryptography, whereby a root public and private key-pair (KrPub and KrPri, respectively) are maintained. Requestee 101 and a database 102 trust certificate authority 104 to certify only legitimate requestor devices 103. Certificate authority 104 certifies these legitimate devices by issuing certificates signed with its private key KrPri. As long as KrPri is protected and solely under the control of certificate authority 104, devices within system 100 will trust that certificate authority 104 must have created any certificate signed with KrPri. Certificate authority 104 also maintains a revocation master list that contains the identity of all requestor devices 103 that are known to be compromised, or non-trusted.

During operation, access to personal information existing within database 102 is provided to requestor 103 under certain circumstances. In particular, requestee 101 receives a request from requester 103 for access to the personal information. As is evident, requestor 103 and requestee 101 are separate electronic devices. In response to the request, requestee 101 determines if the information should be provided, and if so, provides requestor 103 (external entity) with cryptographically protected access information (i.e., a token) allowing requestor to access the specified personal information existing within database 102. As mentioned above, database 102 comprises a personal database separate from electronic device 101. It should be noted that in the preferred embodiment of the present invention database 102 is controlled by a user of electronic device 101, and preferably controlled by the owner of the personal information.

In an alternate embodiment (shown in FIG. 2) access information (i.e., the token) is not provided to requestor 103, but is instead provided to database 102, which then transmits the information to requestor 103. Therefore, in the alternate embodiment, requestee 101 receives a request from requestor 103 for access to the personal information. In response to the request, requestee 101 determines if the information should be provided, and if so, database 102 is provided with cryptographically protected information (i.e., the token) instructing database 102 to transmit the information to requestor 103.

Unlike the prior-art solutions to providing personal information, both the preferred and alternate embodiments provide a mechanism for controlling private information using a device owned and administered by the owner of the personal assets.

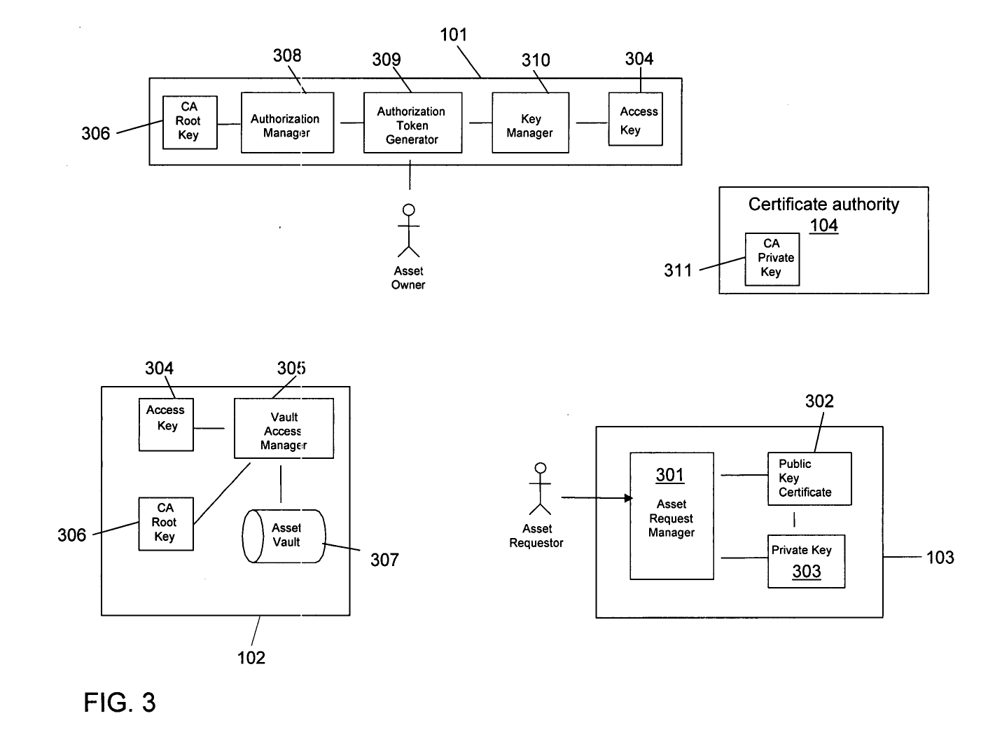

FIG. 3 is a more-detailed block diagram of the systems of FIG. 1 and FIG. 2. As is evident, the system consists of four subsystems: requestee 101 acting as a Token Generation Subsystems (TGS), database 102 acting as a Vault Access Subsystem (VAS), requester 103 acting as an Asset Request Subsystems (ARS), and a Certificate Authority (CA) 104. Database 102 and requestor 103 communicate via a first communication channel (not shown). Requestor 103 and requestee 101 communicate over a second communication channel (not shown). Database 102 and requestee 101 communicate over a third communication channel (not shown) for the purpose of updating asset lists and synchronizing keys. These channels may be the Internet, a wireless LAN or a Bluetooth connection or any other collection of appropriate communication channels.

In the preferred embodiment of the present invention certificate authority 104 maintains a CA private key 311, provides CA root key 306 to requestee 101 and database 102, and uses private key 311 to sign the public-key certificate 302 belonging to requestor 103. The communication between the certificate authority 104 and other entities are typically only needed during system setup or modification (e.g., when a device's public-key certificate is created, renewed or revoked). The public-key certificate 302 issued by Certificate Authority 104 is used to establish the identify and trustworthiness of requester 103. Requestee 101 and Database 102 trust that certificate authority 104 will only create (i.e., digitally sign) certificates for requestor 103 devices that meet certain qualifications. When establishing communications, requestor 103 uses its public-key certificate 302 to identify itself and uses the corresponding private key 303 to prove its identity.

A user controls requestee 101, which creates tokens that grant a requestor access (e.g., read, write, or modify privileges) to the user's personal information contained within asset vault 307. As shown, database 102 contains asset vault 307 that holds elements of asset owner's personal information. These elements may include Internet account numbers and passwords, bank account numbers and PINs, credit card numbers, and issuer's identify. The elements may also include items of a more personal nature such as medical records, pictures, videos, resumes, etc. The access token comprises elements such as:
An identification label for the element or elements (items) within the vault that are requested by this transaction;
The type of actions which are authorized (add item, remove item, read item, append item, modify item);
The identity of the authorized asset requesting party or system operating on behalf of this party;
A validity period (e.g., expiration data); and
A digital signature or message authentication code that certifies the token's authenticity and integrity.

Requestor 103 contacts requestee 101 over a communication channel and makes a request for information. The request is received by authorization manager 308 and the request is analyzed to determine if it was made by a proper entity (e.g., the requester's public-key certificate is examined and verified). The requester 103 will also identify the intended use of the requested information. For example, if the requestor 103 is receiving personal information it can state one of three possible uses for the information: (a) use once and discard, (b) securely retain, (c) no commitments. Once it has been determined that the request was made by a proper entity and the intended use has been approved, a token is generated by generator 309.

Once generated, the token is sent over the channel back to requester 103. In the alternate embodiment the token is sent directly to database 102. When the requestor 103 wants to access the asset, it forwards this token to the database 102 via a communication channel. Whether received from requester 103 or requestee 102, once the token is passed to database 102, it is received by vault access manager 305 and is checked for authenticity. If this check succeeds, vault access manager 305 will verify the identity of requestor 103 and then, if this verification succeeds will grant the requestor 103 access to the information, securely transferring the information to or from the requestor 103. The verification of the identity of requestor 103 can be accomplished using a standard challenge and response authentication scheme (e.g., Secure Socket Layer Transport Layer Security mechanisms) that makes use of public-key certificate 302. Typical authentication schemes will also lead to the establishment of a shared session key that can be used for securely transferring the information to or from the requestor 103 (i.e., the session key can encrypt the information being transferred to prevent eavesdroppers from learning the information).

As mentioned above, database 102 and requestee 101 reside in a storage and execution environment(s) under the control of the asset owner. This need not be the same environment for both, in fact there may be several instances of requestee 101 used by the asset owner—home-based, mobile, limited capability (for delegation to children), etc. Database 102 and requestee 101 may access the communication channels via a personal computer, a set-top box on a cable system, a mobile handset, or an independent device that connects to each of the previously named elements via Bluetooth, IrDA, or cable. In the preferred embodiment of the present invention database 102 supports a user interface to the asset owner for the additional purpose of administrative access and control, e.g., synchronizing keys between database 102 and requestee 101, adding or removing assets, etc.

The security of system 100 relies on two pillars. Firstly, database 102 needs to determine the validity of any received token, and both requestee 101 and database 102 need to determine the identity of the asset requestor (e.g., the requestor 103) prior to providing the requestor with a token or supplying items of personal data, respectively. The authenticity and integrity of the tokens are achieved via access keys 304 that are available to database 102 and the requestee 101. These keys can either be shared, symmetric keys or a public/private key pair. The requestee 101 uses its access key to create a Message Authentication Code (MAC) or digital signature for the token. The database 102 uses its access key to authenticate and check the integrity of the received token. In the case of requestee 101, the access key is managed by key manager 310. Key manager 310 will allow access to the access key (thereby allowing a token to be generated) only if the information owner allowed the access (e.g., via a biometric, password, etc.).

The authenticity of the identity of the authorized party (e.g., requestor 103) is verified using a standard authentication protocol (e.g., Secure Socket Layer Transport Layer Security mechanisms). Requestor 103 possesses a public key and private key 303. These keys form a cryptographic asymmetric key pair (e.g., as used in a scheme such as RSA). The public key is contained in public-key certificate 302, which is signed by the certificate authority 104. The private key 303 is kept secret by asset requester 103 while the public-key certificate 302 is openly communicated to the database 102 or the requestee 101 during authentication protocols. Database 102 and requestee 101 both trust certificate authority 104 and are assured of the trustworthiness any entity possessing a private key 303 (i.e., requestor 103) that corresponds to a public-key certificate signed by certificate authority 104. Database 102 and requestee 101 use their copies of the CA root key 306 to authenticate the validity of the public-key certificate 302.

In addition to the identity of requestor 103 (e.g., the public key), the certificate authority 104 certifies the level of assurance that the asset owner 101 may have about the use of the asset by requestor 103. This can be done in a number of ways, specifically, the certificate authority 104 can represent and certify the integrity of requestor 103 as claimed by auditing the policies and procedures followed by requestor 103. Alternatively, a trusted module could exist within requestor 103 that interprets and enforces the authorization rights granted by requestee 101. Certificate authority 104 could independently certify this module and also that the given requestor 103 is using it.

Database 102 possesses the public root key 306 belonging to certificate authority 104. Root key 306 is needed to verify the requestor's public-key certificate 302. Thus, once requestor 103 registers and is certified by certificate authority 104, database 102 has the ability to confirm the identity of requester 103 or any similarly certified entity that wishes to access content in vault 307. Using public-key certificate 302 belonging to requestor 103, requestor 103 and database 102 are also able to establish a secure session key. This means that the communication of private assets between requestor 103 and database 102 can be encrypted and kept confidential.

The following list gives specific examples of where the above described method of sharing personal information may be utilized. The following examples are not meant to limit, in any way, the application of the above described method to only the examples given below:
1. Joe is logging into his bill paying web site from this home PC. Joe's access is challenged. Joe accepts this challenge and his PC gives his vault system a token. His vault system responds by sending the bill paying web site the account information and credentials needed to access this account.
2. Sue wants to share her stock purchase and sales records with her accountant for tax preparation. She provides this authorization to his PC via a token generated by her cell phone and passed to his PC.
3. Jim wants to share a song he is composing with his friend Steve, without making it available to a wide audience until it is completed. Jim places the digital recording in his vault and uses his token generator to create a token granting Steve access to the song. He shares the token with Steve via a Multimedia Messaging Service (MMS) message from his cell phone. Steve accesses the vault and retrieves the song using the token and MMS messages.
4. Mary needs to provide a proof of purchase receipt from her records in order to get warranty service on a new MP3 player she is returning for service/exchange. The receipt is in her vault (placed there by the store during the purchase transaction). Mary enables the token generator on her cell phone to create a token that is passed to the store's PC, granting the store's PC access to the receipt.
5. Sam wants to download a pay-per-view movie to his personal video recorder from a web server. He needs to make a one-time payment for this transaction. The payment information is retained in his home information management system (extended set-top box); the token generator is accessed via his personal PC.
6. Larry needs to share a strategy paper that he is creating at home with two coworkers. He places the document in his vault and emails each of the coworkers an access token.
7. Jane has just opened an account that allows her download access to XYZ collection of digital recordings; she authorizes the service to store her account information and passwords in her vault. When she upgrades to the “gold” service level, she authorizes the service to update her account information.

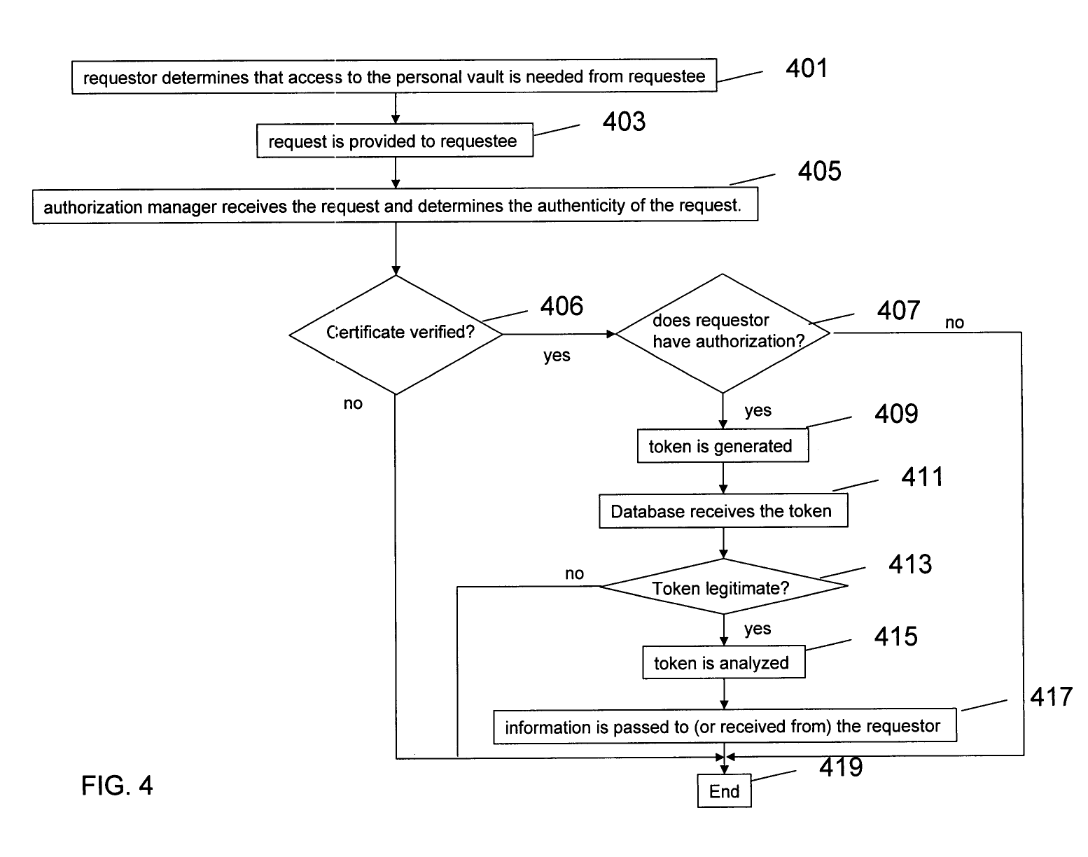

FIG. 4 is a flow chart showing operation of the system of FIG. 3 in accordance with the preferred embodiment of the present invention. The logic flow begins at step 401 where requester 103 determines that access to the personal vault is needed from requestee 101. In particular, an individual (asset requester 103) will provide the request to asset request manager 301. At step 403, asset request manager 301 provides the request to requestee 101. As discussed above, in order to assure that the request is from an appropriate source, the requestor 103 supplies a certificate containing its name, Internet address, signed by a certificate authority 104, trusted by both the database 102 and requestee 101.

Continuing, at step 405 authorization manager 308 receives the request and determines the authenticity of the request. At step 406, requestee device 101 first verifies the public-key certificate 302 belonging to the requester 103. If the certificate 302 is not successfully verified as legitimate, the logic flow ends at step 419. Otherwise, the requestee device 101 displays, in some way, the information requested to the user of requestee device 101 and receives an input response such as accept or deny. At step 407, authorization manager 308 determines if requestor 103 has authorization to receive the requested material based upon the user input in the prior step, and if not, the logic flow ends at step 419. Otherwise the logic flow continues to step 409 where a token is generated by generator 309 and, in the first embodiment, is passed to asset request manager 301. In the second embodiment, the token is passed directly to database 102. As discussed above, the token comprises authorization information that identifies the token as being legitimate, as well as identifying the information access privileges that should be granted to requestor 302.

Continuing, at step 411, vault access manager 305 receives the token. At step 413 the asset manager 305 determines if the token is legitimate, and if so, the logic flow continues to step 415, otherwise, the logic flow ends at step 419. In order to determine if the token is legitimate (i.e., step 413), the access manager uses a cryptographic algorithm with its shared secret key or public key to verify the token's message authentication code or digital signature, respectively. At step 415, the token is analyzed to determine the information that is being accessed, and at step 417, the information is passed to (or received from) the asset request manager 301. The logic flow then ends at step 419.

While the invention has been particularly shown and described with reference to a particular embodiment, it will be understood by those skilled in the art that various changes in form and details may be made therein without departing from the spirit and scope of the invention. For example, it is intended that such changes come within the scope of the following claims.

1. A method for providing access to personal information, the method comprising the steps of:
receiving, by an electronic device, a request for access to the personal information, the request originating from an entity external to the electronic device;
providing the external entity with cryptographically protected access information allowing the entity access to the personal information existing within a personal database also existing external to the electronic device.

2. The method of claim 1 wherein the step of providing the external entity with the cryptographically protected access information comprises the step of providing the external entity with a token, the token comprising information taken from the group consisting of:
an identification label for an element within the database,
a type of action to be performed on the database,
an identity of a requesting party,
a validity period, and
a digital signature or message authentication code that certifies the token's authenticity and integrity.

3. The method of claim 1 wherein the database is controlled by a user of the electronic device.

4. The method of claim 1 wherein the database is controlled by an owner of the personal information.

5. The method of claim 1 wherein the database and the electronic device is controlled by an owner of the personal information.

6. The method of claim 1 wherein the step of providing the external entity with cryptographically protected access information allowing the entity access to the personal information comprises the step of providing the external entity with a token allowing the entity to read the personal information.

7. The method of claim 1 wherein the step of providing the external entity with cryptographically protected access information allowing the entity access to the personal information comprises the step of providing the external entity with a token allowing the entity to write personal information into the database.

8. A method for providing access to personal information, the method comprising the steps of:
receiving, on an electronic device, a request for the personal information, the request originating from an entity external to the electronic device;
providing a personal database, external to the electronic device, with cryptographically protected access information instructing the database to forward the personal information to the external entity.

9. The method of claim 8 wherein the step of providing the personal database with the cryptographically protected access information comprises the step of providing the database with a token, the token comprising information taken from the group consisting of:
an identification label for an element within the database,
a type of action to be performed on the database,
an identity of a requesting party,
a validity period, and
a digital signature or message authentication code that certifies the token's authenticity and integrity.

10. The method of claim 8 wherein the database is controlled by a user of the electronic device.

11. The method of claim 8 wherein the database is controlled by an owner of the personal information.

12. The method of claim 8 wherein the database and the electronic device is controlled by an owner of the personal information.

13. The method of claim 8 wherein the step of providing the database with cryptographically protected access information comprises the step of providing the database with a token allowing the external entity to read the personal information.

14. The method of claim 8 wherein the step of providing the database with cryptographically protected access information allowing the entity access to the personal information comprises the step of providing the database with a token allowing the entity to write personal information into the database.

15. An electronic device comprising:
an authorization manager receiving a request for the personal information, the request originating from an entity external to the electronic device and verifying the requester of the personal information as legitimate; and
a token generator, providing either an external database or the external entity with cryptographically protected access information instructing the database to forward the personal information to the external entity.

16. The apparatus of claim 15 wherein the cryptographically protected access information comprises a token comprising information taken from the group consisting of:
an identification label for an element within the database,
a type of action to be performed on the database,
an identity of a requesting party,
a validity period, and
a digital signature or message authentication code that certifies the token's authenticity and integrity.

17. The method of claim 15 wherein the database is controlled by a user of the electronic device.

18. The method of claim 15 wherein the database is controlled by an owner of the personal information.
